(19) United States
(12) Patent Application Publication
(10) Pub. No.: US 2026/0237582 A1
(43) Pub. Date: Aug. 13, 2026

(54) RELAY COMPRISING ARC INDUCTION SHIELD STRUCTURE

(71) Applicant: LS E-MOBILITY SOLUTIONS CO., LTD., Cheongju-si, Chungcheongbuk-do (KR)

(72) Inventor: Yong Hwan KIM, Cheongju-si, Chungcheongbuk-do (KR)

(21) Appl. No.: 19/470,888

(22) PCT Filed: Jan. 5, 2024
(86) PCT No.: PCT/KR2024/000249

§ 371 Date: Sep. 30, 2025

(30) Foreign Application Priority Data
Apr. 10, 2023 (KR) 10-2023-0046893

(51) Int. Cl. H01H 50/38; H01H 50/02; H01H 50/56

(52) U.S. Cl. CPC H01H 50/38; H01H 50/02; H01H 50/56

(57) ABSTRACT

The present disclosure provides a relay comprising an arc induction shield structure so that damage to other constituent elements can be prevented while an arc is effectively extinguished. The relay comprising an arc induction shield structure, according to one aspect of the present disclosure, comprises a fixed contact, a movable contact, a housing and an arc chamber, and may comprise an arc induction pin.

### CROSS-REFERENCE TO RELATED APPLICATIONS

This application is the National Stage filing under 35 U.S.C. 371 of International Application No. PCT/KR2024/000249, filed on Jan. 5, 2024, which claims the benefit of earlier filing date and right of priority to Korean Application No. 10-2023-0046893, filed on Apr. 10, 2023, the contents of which are all hereby incorporated by reference herein in their entirety.

### FIELD

The present disclosure relates to a relay, and more specifically, to a relay having an arc induction shield structure to effectively extinguish an arc and prevent damage to other components.

### BACKGROUND

A direct current (DC) relay is a device configured to transmit a mechanical drive or current signal using a principle of an electromagnet, and is also referred to as a magnetic switch. The DC relay is generally classified as an electrical circuit switching device.

The DC relay is used to switch power on and off, and widely utilized in industrial, residential, and automotive applications.

In particular, electric vehicles such as hybrid vehicles, fuel cell vehicles, golf carts, and electric forklifts are equipped with an electric vehicle relay for supplying or cutting off battery power to a power generation device and electrical components. The electric vehicle relay is one of very important key components in electric vehicles.

FIG. 1 is a cross-sectional view of a DC relay according to one embodiment of the related art.

Referring to the drawing, a DC relay 1 may be largely divided into an arc extinguishing module 10 and a driving module 20.

The arc extinguishing module 10 is connected to an external device to supply power.

The driving module 20 controls opening and closing of a contact by using an electrical signal to supply or cut off power to the arc extinguishing module 10 connected to the external device.

At this time, the driving module 20 may have core portions of a movable core 23 and a fixed core 25 arranged therein and includes a shaft 21, and may be distinguished from the arc extinguishing module 10 by a support plate 26.

Meanwhile, in the relay 1, the arc extinguishing module 10 generally conducts electricity through contact between a fixed contact 11 and a movable contact 12.

The fixed contact 11 is connected to the external device to supply power. The movable contact 12 is located at a lower end of the fixed contact 11 and supplies or cuts off power to the external device by coming into contact with or being separated from the fixed contact 11.

The movable contacts 12 is coupled to the shaft 21 of the driving module 20 and performs contact or separation with the fixed contact 11 through switching.

In other words, according to contact and separation between the fixed contact 11 and the movable contact 12, conduction through the DC relay 1 is either allowed or blocked.

As described above, movement of the movable contact 12 is performed by the shaft 21 of the driving module 20.

Meanwhile, the relay 1 includes a contact pressure spring 13 configured to apply elastic force to the movable contact 12 when the relay 1 is opened or closed by the contact or the separation between the fixed contact 11 and the movable contact 12.

In other words, one contact pressure spring 13 is arranged at a bottom of the movable contact 12, the one contact pressure spring 13 being configured to, when the movable contact 12 comes into contact with the fixed contact 11, apply elastic force to the movable contact 12 in a direction in which the movable contact 12 is to be separated from the fixed contact 12.

At this time, the contact pressure spring 13 is located between the movable contact 12 and an upper side of the shaft 21.

The contact pressure spring 13 functions to maintain a state of contact between the movable contact 12 and the fixed contact 11 at a certain pressure or greater, and also reduce a moving speed of the movable core 23 and the shaft 21 when the movable contact 12 is separated from the fixed contact 11, thus alleviating impact force when the movable core 23 comes into contact with a cylinder (not shown) to thereby suppress occurrence of noise and vibration.

Meanwhile, referring to FIGS. 2 and 3, in a relay structure, when the fixed contact 11 is separated from the movable contact 12, an arc A is generated between the fixed contact 11 and the movable contact 12.

This arc is a flow of current at a high voltage and at a high temperature.

Therefore, the generated arc needs to be quickly discharged from the DC relay 1 through a preset path before affecting other components.

The path of the discharging of the arc is defined by a magnet (magnetic material) included in the DC relay 1.

The magnet generates a magnetic field inside a space in which the fixed contact 11 comes into contact with the movable contact 12, and the discharging path of the arc A may be defined by electromagnetic force generated by the generated magnetic field and the flow of the current.

Meanwhile, the fixed contact 11 and the movable contact 12 are arranged in a semi-enclosed space referred to as an arc chamber 15.

Accordingly, the arc A generated by contact and separation between the fixed contact 11 and the movable contact 12 is also generated inside the arc chamber 15.

The generated arc A extends and is extinguished in a space inside the arc chamber 15.

In other words, in the DC relay 1, as the movable contact 12 moves away from the fixed contact 11, the arc A described above is generated, and as a length of the arc A increases in the chamber space, the generated arc A is extinguished.

Meanwhile, the arc generates a large amount of heat together, and the generated heat is discharged to outside of the arc chamber 15 through the arc chamber 15 and the magnet.

When an extension length of the arc A generated as described above increases, an arc extinguishing effect also increases.

When the extension length of the generated arc A is not properly secured, the arc A continues to remain at a minimum distance between the fixed contact 11 and the movable contact 12, which may eventually lead to damage to a product.

For example, a contact portion between the movable contact 12 and the fixed contact 11 may melt due to the arc A that has remained between the fixed contact 11 and the movable contact 12 and the heat generated with the arc A. Thus, fusion between the movable contact 12 and the fixed contact 11 may occur.

Meanwhile, a direction of the generated arc A is not determined, which may affect the shaft 21 or the contact pressure spring 13 during an arc extinguishing process.

In other words, there has been such a problem that in a process of extinguishing the arc A, the arc A may move toward the shaft 21 or the contact pressure spring 13, and due to frequent contact with the arc A, mechanical lifespans of the shaft 21 and the contact pressure spring 13 may be eventually reduced (see FIG. 3).

Accordingly, with respect to the DC relay 1, there is an urgent need to improve the relay 1 such that the arc A generated as the movable contact 12 moves away from the fixed contact 11 may be sufficiently extended for arc extinguishing, while the arc A is prevented from coming into contact with components such as the shaft 21 or the contact pressure spring 13 to thereby enhance mechanicals lifespan and electrical reliability of the components.

### SUMMARY

Therefore, to obviate those problems, an objective of the present disclosure is to provide a relay having an arc induction shield structure to effectively extinguish an arc and prevent damage to other components.

Another objective of the present disclosure is to provide a relay having an arc induction shield structure so that a generated arc does not remain at a minimum distance between a fixed contact and a movable contact.

Still another object of the present disclosure is to provide a relay having an arc induction shield structure configured to induce a generated arc to be extended to a sufficient length.

The present disclosure may be embodied in many different forms and should not be construed as being limited to the embodiments set forth herein. Additional aspects will be set forth in part in the description which follows and, in part, will be apparent from the description, or may be learned by practice of the presented embodiments.

To achieve these and other advantages and in accordance with the purpose of the present disclosure, as embodied and broadly described herein, there is provided a relay having an arc induction shield structure.

As one embodiment, a relay having an arc induction shield structure includes: a fixed contact electrically connected to an external power source or load; a movable contact positioned below the fixed contact to be linearly movable and brought into contact with or separated from the fixed contact; a housing configured to accommodate, in a mounting space, the movable contact and a contact pressure spring supporting a lower portion of the movable contact to apply elastic force, and to move upward and downward by a shaft coupled to a lower portion of the housing; an arc chamber configured to accommodate the fixed contact, the movable contact, and the housing in a chamber space; an arc induction pin arranged on one side of the chamber space to induce a direction of an arc, which has been generated, such that the arc extends; and an arc guard portion having a shape surrounding the housing and configured to block the generated arc from moving in a direction toward the contact pressure spring.

At this time, the arc induction pin is made of a magnetic material having a column shape with a preset length and diameter, has a length greater than a length of the movable contact in a widthwise direction of the movable contact, and is arranged to have a length in a front-and-back direction.

As an embodiment, the arc induction pin includes a column portion having a set length and diameter; and head portions protruding to define stopping parts at both end portions of the column portion.

Meanwhile, the arc guard portion may include a first guard made of a magnetic material and arranged on a lower surface of the movable contact to guide a direction of the arc.

As an example, the first guard may have a size and a shape each identical to those of the lower surface of the movable contact, and include a first plate arranged to be in contact with the lower surface of the movable contact.

In addition, the first guard may further include second plates extending downward from both longitudinal end portions thereof.

Meanwhile, the housing includes a body having a shape of an enclosure with open upper and both side portions, defining the mounting space therein, and having a lower portion coupled to the shaft, and a holder plate configured to partially block the open upper portion of the body and support an upper surface of the movable contact by being in contact with the upper surface of the movable contact.

At this time, the arc guard portion may have a structure including a second guard made of an insulator and configured to cover both open side portions in the body.

As an embodiment, the second guard includes a first plate having a size and a shape such that the both open side portions in the body may be covered, and second plates extending from both side portions of the first plate in a direction toward the mounting space.

In addition, the body may have protrusions arranged on both side surfaces at an outer end portion, and the second plates may each have protrusion grooves corresponding to the protrusions. Thus, as the protrusions and the protrusion grooves are coupled to each other, the second guard may be detachably coupled to the housing.

Meanwhile, in an embodiment of the present disclosure, the arc induction pin is arranged to have a spacing in a direction away from an upper surface of an insulating plate, which blocks a lower portion of the chamber space and has the shaft inserted therethrough, and to have a spacing in a longitudinal direction from a longitudinal end portion of the movable contact.

In addition, the insulating plate further includes a guard wall portion arranged thereon, the guard wall portion being configured to support the arc induction pin.

As an example, the guard wall portion may include a guard wall having a set height and width on the upper surface of the insulating plate and arranged vertically, and a rib extending from one surface of the guard wall to be inclined in a direction away from the movable contact.

As needed, the guard wall may extend to a height of an upper end portion of the movable contact.

In addition, the rib may have a seating groove formed on one side thereof, and the arc induction pin may be seated in the seating groove.

According to the configuration as described above, a relay having an arc induction shield structure according to the present disclosure may have an arc induction pin in a chamber space and induce a generated arc to the arc induction pin to extend the generated arc to a length sufficient for arc extinguishing. Thus, an effect of effectively extinguishing an arc may be obtained.

In addition, the relay having the arc induction shield structure according to the present disclosure has such an effect that, as the generated arc is induced to the arc induction pin and extended, the generated arc may be prevented from coming into contact with a component such as a shaft or a contact pressure spring.

In addition, the relay having the arc induction shield structure according to the present disclosure has an effect of improving mechanical lifespans and electrical reliability of components such as a shaft or a contact pressure spring by blocking any potential arc from coming into contact with the components by using an arc guard portion which surrounds a housing having a contact pressure spring arranged in a mounting space.

In addition, the relay having the arc induction shield structure according to the present disclosure has an effect of preventing fusion between a fixed contact and a movable contact and damage to a product, since a generated arc is induced to an arc induction pin and the generated arc does not continue to remain at a minimum distance between the fixed contact and the movable contact.

Effects of the present disclosure are not limited to the effects described above, and should be understood to include all effects that may be inferred from configurations described in the detailed description or claims of the present disclosure.

### BRIEF DESCRIPTION OF THE DRAWINGS

FIG. 1 is a diagram illustrating a relay in the related art.

FIGS. 2 and 3 are schematic diagrams illustrating an arc generated as a movable contact and a fixed contact become separated from each other during opening in the relay in the related art.

FIG. 4 is a diagram illustrating a relay having an arc induction shield structure according to an embodiment of the present disclosure.

FIG. 5 is an enlarged view of a chamber space in the relay having the arc induction shield structure of FIG. 4.

FIG. 6 is a perspective view illustrating a portion other than an arc chamber in the relay having the arc induction shield structure according to an embodiment of the present disclosure.

FIG. 7 is an enlarged view illustrating a portion including an arc induction pin in the relay having the arc induction shield structure of FIG. 6.

FIG. 8 is a combined cross-sectional perspective view illustrating a movable contact, a housing, a shaft, and an arc guard portion in the relay having the arc induction shield structure according to an embodiment of the present disclosure.

FIG. 9 is an exploded perspective view of FIG. 7.

FIG. 10 is a diagram illustrating that, in the relay having the arc induction shield structure according to an embodiment of the present disclosure, a generated arc is induced and extended to the arc induction pin, and then, blocked and extinguished by an arc guard portion.

FIG. 11 is a diagram illustrating a guard wall portion of a relay having an arc induction shield structure according to another embodiment of the present disclosure.

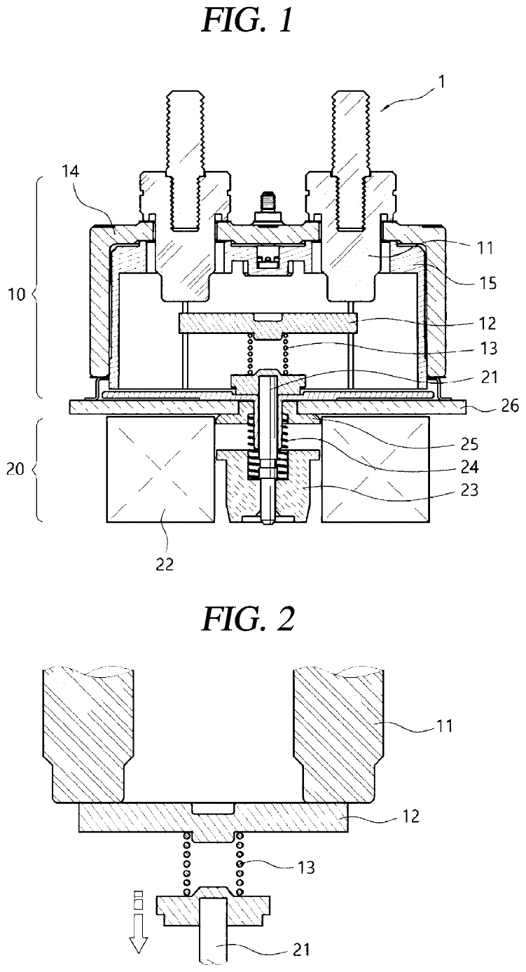

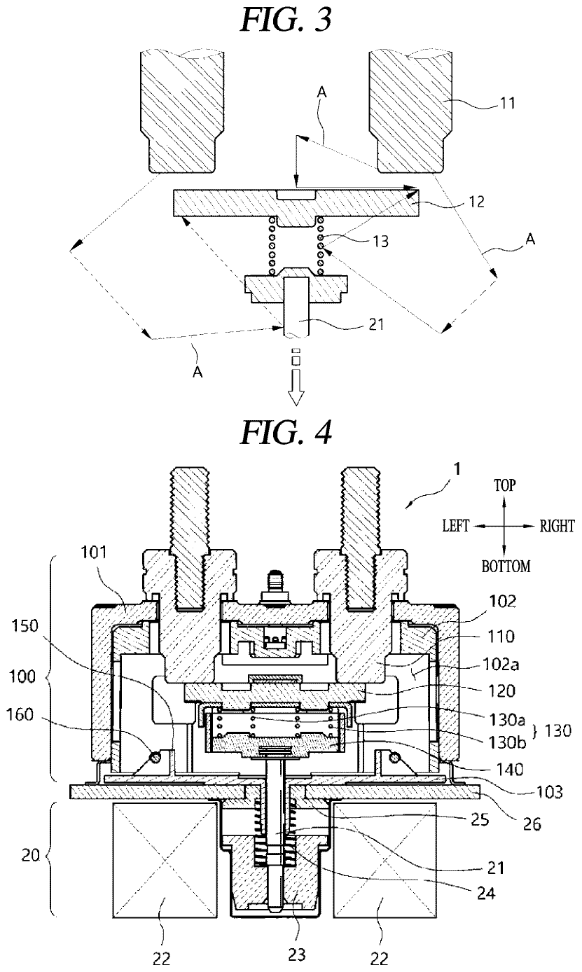

### DETAILED DESCRIPTION

The present disclosure, as the best mode, provides a relay having an arc induction shield structure including: a fixed contact electrically connected to an external power source or load; a movable contact configured to come into contact with or be separate from the fixed contact; a contact pressure spring configured to support a lower portion of the movable contact to apply elastic force; and an arc induction pin configured to induce a direction of an arc, which has been generated, to thereby cause the arc to extend.

Hereinafter, embodiments of the present disclosure will be described in detail with reference to the accompanying drawings so that those skilled in the art may easily implement the present disclosure. The present disclosure may, however, be implemented in many different forms and should not be construed as being limited to the embodiments set forth herein. In the description of the inventive disclosure, certain detailed explanations are omitted when it is deemed that they may unnecessarily obscure the essence of the present disclosure. Like numbers refer to like elements throughout the description of the figures.

Terms or words used in this specification and claims should not be interpreted as being limited to have a general meaning or a meaning defined in a dictionary, but should be interpreted as having a meaning and a concept which are consistent with the technical ideas of the present disclosure, based on a principle such that an inventor may properly define concepts of the terms to explain the disclosure of the inventor by using an optimum method.

Therefore, example embodiments will be described in detail with reference to the accompanying drawings. It should be understood, however, that there is no intent to limit example embodiments to the particular forms disclosed, but on the contrary, example embodiments are to cover all modifications, equivalents, and alternatives falling within the scope of the present disclosure.

In this specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

When a component is “in front of,” “at a rear of,” “above,” or “below” another component, this means that the component is disposed “in front of,” “in rear of,” “above,” or “below” the another component to be in direct contact with the another component, or to have an intervening component therebetween, unless the context clearly indicates otherwise. In addition, when a component is referred to as being “connected to” another component, this means that the component is directly or indirectly connected to the another component, unless the context clearly indicates otherwise.

Hereinafter, a relay having an arc induction blocking structure according to one embodiment of the present disclosure is described with reference to the accompanying drawings.

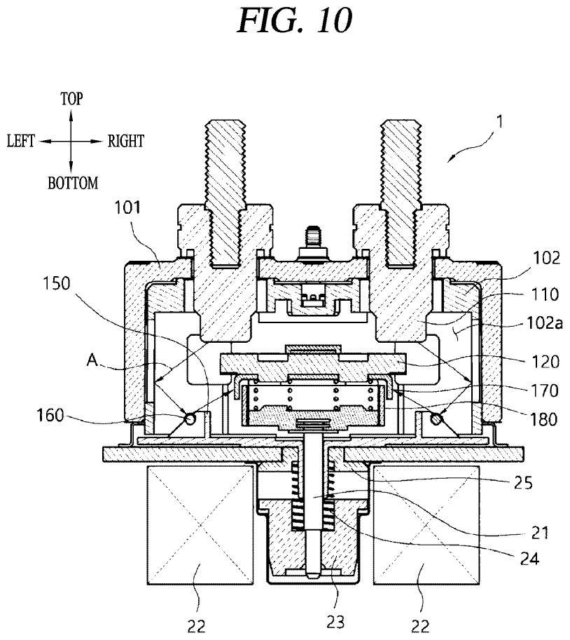

Referring to FIGS. 4 to 11, a relay 1 having an arc induction shield structure according to an embodiment of the present disclosure sufficiently extends an arc A generated (that occurs) as a movable contact 120 moves away from a fixed contact 110 during opening of the relay 1 to thereby effectively extinguish the arc A.

In addition, the relay 1 having the arc induction shield structure according to an embodiment of the present disclosure blocks the generated arc A from moving toward contact pressure springs 130 or a shaft 21, thereby improving mechanical lifespans and electrical reliability of components.

Thus, the relay 1 having the arc induction shield structure according to an embodiment of the present disclosure has a structure including an arc extinguishing module 100 and a driving module 20, and includes an arc chamber 102 having a chamber space 102a, the fixed contact 110, the movable contact 120, a housing 140, and a plurality of the contact pressure springs 130.

In addition, the relay 1 in the present disclosure includes an arc induction pin 160 and an arc guard portion G.

In other words, the relay 1 having the arc induction shield structure according to an embodiment of the present disclosure includes: the fixed contact 110 electrically connected to an external power source or load; the movable contact 120 positioned to be linearly movable below the fixed contact 110 and configured to come into contact with or be separate from the fixed contact 110; a housing 140 configured to accommodate, in a mounting space 146, the movable contact 120 and the contact pressure springs 130 supporting a lower portion of the movable contact 120 to apply elastic force, and to move upward and downward by the shaft 21 coupled to a lower portion of the housing 140; and the arc chamber 102 configured to accommodate the fixed contact 110, the movable contact 120, and the housing 140 in the chamber space 102a.

In addition, the relay 1 includes an arc induction pin 160 arranged on one side of the chamber space 102a to induce a direction of the generated arc A and cause the arc A to extend; and an arc guard portion G having a shape surrounding the housing 140 and configured to block the generated arc A from moving in a direction toward the contact pressure springs 130.

Accordingly, the arc A generated when the relay 1 is opened is sufficiently extended to be extinguished, and the generated arc A is prevented from coming into contact with components such as the contact pressure springs 130, thereby improving a mechanical lifespan and electrical reliability of the relay 1.

Hereinafter, components constituting the relay 1 having the arc induction shield structure in the present disclosure as described above will be described below, respectively.

As shown in FIGS. 4 to 6, the fixed contact 110, the movable contact 120, the housing 140, the contact pressure springs 130, the arc induction pin 160, and the arc guard portion G, which constitute the relay 1 having the arc induction shield structure according to an embodiment of the present disclosure, are arranged in the arc chamber 102 inside a cover frame 101.

The cover frame 101 defines an outer shape of the arc extinguishing module 100, and although not illustrated, may be integral with or separate from a lower cover frame (not shown) having an outer shape defined by the driving module 20.

The cover frame 101 may be made of an insulating material, and is intended to prevent current applied during operation of the relay 1 from being arbitrarily leaked to outside.

The cover frame 101 may be made of a highly rigid material.

This is to prevent damage caused by the arc A generated in an external environment and in an inner space where the relay 1 is installed.

The cover frame 101 may be also made of a synthetic resin material such as reinforced plastic.

The cover frame 101 may have any shape in which various components may be mounted.

In the drawing, the cover frame 101 is illustrated as being distinguished from the driving module 20 by a support plate 26. However, as described above, the cover frame 101 may be also integral with the lower cover frame (not shown) including the driving module 20.

The lower cover frame may be made of a same material as that of the cover frame 101 described above to perform a same function.

The arc chamber 102 has a box shape with an open low surface and is installed on an upper side in the cover frame 101 constituting the arc extinguishing module 100.

The arc chamber 102 is made of a material with excellent insulation, pressure resistance, and heat resistance properties to extinguish the arc A generated at the movable contact 120 and the fixed contact 110 when an electrical circuit is opened or closed.

In other words, the arc chamber 102 extinguishes, in an inner space (chamber space), an arc generated by separation between the fixed contact 110 and the movable contact 120. Thus, the arc chamber 102 may also be referred to as an “arc extinguishing portion.”

The fixed contact 110, the movable contact 120, the housing 140, the contact pressure springs 130, the arc induction pin 160, and the arc guard portion G described above are accommodated and arranged in the inner space of the arc chamber 102.

In the inner space of the arc chamber 102, the movable contact 120 is accommodated to be liftable and lowerable by the shaft 21 of the driving module 20 coupled to the housing 140.

The movable contact 120 may be lifted and lowered in a direction toward or opposite to the fixed contact 110 in a state of being accommodated in the inner space of the arc chamber 102.

Meanwhile, the inner space of the arc chamber 102 may be filled with gas for arc extinguishing.

The arc extinguishing gas causes the generated arc A to be extinguished and discharged to outside of the relay 1 of direct current through a preset path.

Thus, a communication hole (not shown) may be arranged through a wall surrounding the inner space of the arc chamber 102.

As described above, the arc chamber 102 may be made of an insulating material having high pressure resistance and high heat resistance.

In one embodiment, the arc chamber 102 may be made of a ceramic material.

Meanwhile, the fixed contact 110 included in the relay 1 having the arc induction shield structure according to an embodiment of the present disclosure is electrically connected to an external power source or load, and may be configured in plurality as needed.

As one example, in the drawing, fixed contacts 110 are illustrated as being included in a pair, and the pair of fixed contacts 110 are fixedly installed in the cover frame 101 and the arc chamber 102.

The fixed contacts 110 are partially exposed to outside of the cover frame 101, and may be electrically connected to an external power source or load.

One of the pair of fixed contacts 110 may be connected to a power source side, and another of the pair may be connected to a load side.

In addition, the movable contact 120 included in the relay 1 having an arc induction shield structure according to an embodiment of the present disclosure has a length that may come into contact with a plurality of fixed contacts 110.

The movable contact 120 is positioned to be linearly movable below the fixed contacts 110 to come contact with or be separated from the fixed contacts 110.

The moving contact 120 is configured as a plate body with a predetermined length and installed below the fixed contacts 110.

The movable contact 120 is configured to be linearly movable upward and downward by the shaft 21 constituting the driving module 20 arranged on a lower side of the relay 1, and comes into contact with or is separated from the fixed contacts 110 according to control by the relay 1.

In other words, the movable contact 120 comes into contact with the fixed contacts 110 according to application of control power (when the relay is closed).

Accordingly, the relay 1 according to the embodiment of the present disclosure may be electrically connected to an external power source and load.

Conversely, the movable contact 120 is separated from the fixed contacts 110 when the applied control power is cut off (when the relay is opened).

Accordingly, the electrical connection of the relay 1 according to the embodiment of the present disclosure to the external power source and load is cut off.

In detail, the movable contact 120 moves in a direction toward the fixed contacts 110 to come into contact with the fixed contacts 110, or moves in an opposite direction to the fixed contacts 110 to be separated from the fixed contacts 110.

For example, the movable contact 120 may be made of a conductive material.

Therefore, when the movable contact 120 come into contact with the fixed contacts 110, electrical connection to the external power source or load may be performed.

Meanwhile, desirably, the movable contact 120 may be located to be adjacent to the fixed contacts 110.

Meanwhile, as described above, the movable contact 120 has a length to be capable of coming into contact with the plurality of fixed contacts 110, and the movable contact 120 is configured to have a length greater than a width.

In the illustrated embodiment, a longitudinal direction is a left-to-right direction, and a width direction is a front-to-back direction.

Meanwhile, desirably, the movable contact 120 may be simultaneously in contact with or separated from the plurality of fixed contacts 110.

Accordingly, the movable contact 120 has a plate shape in which a longitudinal length is greater than a width length.

In addition, the movable contact 120 is configured to have a length greater than a distance between a fixed contact 110 and a neighboring fixed contact 110.

Meanwhile, in the drawing, the movable contact 120 moves as controlled by the housing 140 which is to be described later, and may perform lifting/lowering movement (up-and-down movement) according to the housing 140 having the shaft 21 coupled to a lower portion.

The housing 140 constituting the relay 1 having the arc induction shield structure according to an embodiment of the present disclosure accommodates the movable contact 120 in the mounting space 146.

In addition, the housing 140 has a structure of being lifted or lowered by the shaft 21 of the driving module 20 coupled to the lower portion.

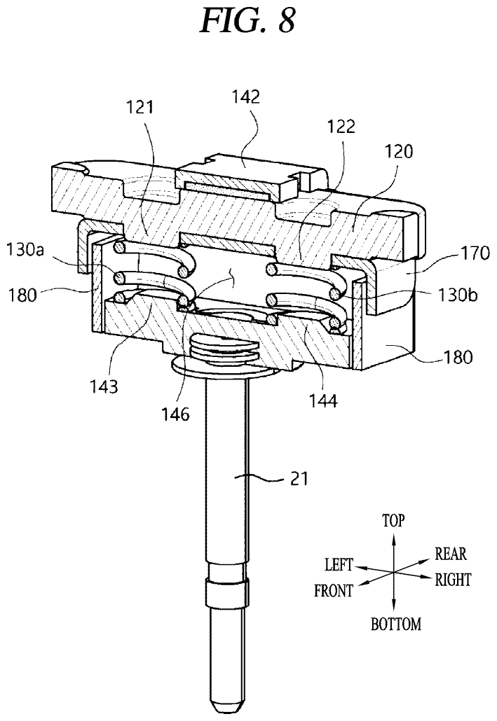

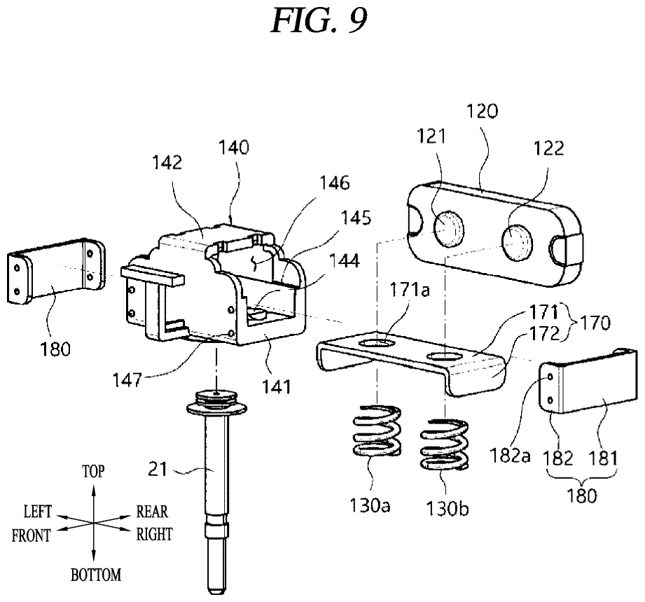

As one specific embodiment, referring to FIGS. 8 and 9 together, the housing 140 described above has a body 141 in a form of an enclosure with open upper and both side portions.

The housing 140 has the mounting space 146 arranged inside the body 141, and has a lower portion coupled to the shaft 21 of the driving module 20.

In addition, the housing 140 includes a holder plate 142 partially blocking the open upper portion of the body 141 and supporting an upper portion of the movable contact 120.

Accordingly, the movable contact 120 is mounted by being inserted laterally into the mounting space 146 of the housing 140, and prevented from being separated as being blocked in an upper direction by the holder plate 142 described above.

In addition, desirably, the holder plate 142 may be configured to have a width of a lower surface with a length identical to that of the movable contact 120.

Accordingly, the body 141 of the housing 140, having the holder plate 142 arranged on an upper portion, causes a width portion of the movable contact 120 to come into contact with an inner side wall in the mounting space 146, and the movable contact 120 may be prevented from shaking or being separated to outside while being lifted or lowered.

Meanwhile, referring to FIG. 9, the body 141 constituting the housing 140 further constitutes a stopping part 145 on one side of a lower portion of the inner side wall defining the mounting space 146.

Desirably, the stopping part 145 may be arranged on both sides of the inner side wall.

Accordingly, the movable contact 120 gets caught on the stopping part 145 when moving downward, and thus, does not further move downward.

This prevents the movable contact 120 from being excessively pressed downward due to excessive contact (compression) with the fixed contact 110, and allows stable opening and closing operations of the relay 1.

Meanwhile, the shaft 21 of the driving module 20, which is coupled to the lower portion of the housing 140, has an upper end supporting the lower portion of the housing 140, and a lower end coupled to a movable core 23 to transmit up-and-down movement of the movable core 23 to the housing 140.

In addition, the housing 140 transmits up-and-down movement of the shaft 21 to the movable contact 120 located in the mounting space 146.

Accordingly, the movable contact 120 is supported by the housing 140 and lifted and lowered in an up-and-down direction to come into contact with or be separated from the fixed contacts 110.

Meanwhile, when the relay 1 is closed, the movable contact 120 comes into contact with the fixed contacts 110.

At this time, the contact pressure springs 130 are arranged in the mounting space 146 of the housing 140 so that the movable contact 120 may maintain a contact state with the fixed contacts 110 at a certain pressure or greater.

The contact pressure springs 130 allow the movable contact 120 to maintain a state of contact with the fixed contacts 110 at a certain pressure or greater.

In addition, the contact pressure springs 130 reduce a moving speed of the movable core 23 and the shaft 21 when the movable contact 120 is separated to be apart from the fixed contact 110 during opening of the relay 1, thus relieving impact force when the movable core 23 and a cylinder come into contact to thereby suppress occurrence of noise and vibration.

Meanwhile, the relay 1 having the arc induction shield structure according to an embodiment of the present disclosure is configured to accommodate the plurality of contact pressure springs 130 in the mounting space 146 of the housing 140 to apply elastic force by supporting the lower portion of the movable contact 120 described above.

Desirably, according to a number of the fixed contacts 110, a number of the contact pressure springs 130 may be configured to correspond to the number of the fixed contacts 110.

This is to arrange the contact pressure springs 130 at respective positions in which the fixed contacts 110 apply pressure to the movable contact 120 to thereby relieve an impact.

Alternatively, since the movable contact 120 has a plate shape with a length, the contact pressure springs 130 may have a structure of being arranged on both sides of the movable contact 120, respectively, to relieve an impact.

As one embodiment of the relay 1 according to an embodiment of the present disclosure, in the drawing, the fixed contacts 110 are configured as a pair spaced apart from each other by a spacing.

In addition, the contact pressure springs 130 constituting the relay 1 having the arc induction shield structure according to an embodiment of the present disclosure are configured as two contact pressure springs 130 corresponding to the number of the fixed contacts 110 described above.

This is to minimize an impact by supporting and cushioning respective portions of the fixed contacts 110 which are pressed during contact with the movable contact 120 The contact pressure springs 130 may include a first pressure spring 130a arranged on a left side of the movable contact 120 and a second pressure spring 130b arranged on a right side of the movable contact 120.

Meanwhile, the fixed contacts 110 are configured as a pair spaced apart from each other on an upper portion of the cover frame 101.

At this time, desirably, the first pressure spring 130a and the second pressure spring 130b may be arranged to have a center axial line relatively close to a center axial line of the fixed contacts 110.

In other words, it would be desirable to minimize a distance between the center axial line of the contact pressure springs 130 and the center axial line of the fixed contacts 110.

This is to further alleviate an impact by placing the contact pressure springs 130 to be closer to a position in which the fixed contact 110 and the movable contact 120 come into contact to cause occurrence of an impact.

Meanwhile, the relay 1 having the arc induction shield structure according to an embodiment of the present disclosure is configured to prevent the contact pressure springs 130 from being separated or shaken during relay operation.

Thus, the movable contact 120 may have, on a lower surface, a first protrusion 121 into which an upper end of the first contact pressure spring 130a is fit and supported and a second protrusion 122 into which an upper end of the second contact pressure spring 130b is fit and supported.

In addition, the housing 140 may have, in the mounting space 146 of the body 141, a first fitting protrusion 143 into which a lower end of the first pressure spring 130a is fit and supported and a second fitting protrusion 144 into which a lower end of the second pressure spring 130b is fit and supported (see FIGS. 8 and 9).

The plurality of contact pressure springs 130 absorb and withstand an impact that occurs when the fixed contacts 110 and the movable contact 120 collide to come into contact with each other.

Accordingly, resultantly, the plurality of contact pressure springs 130 may suppress occurrence of arcs during operation of the relay 1 to thereby improve electrical reliability of the relay 1.

The first protrusion 121 and the second protrusion 122, and the first fitting protrusion 143 and the second fitting protrusion 144, each as described above, have a shape that may be included in spring steel wires of the contact pressure springs 130, and may have a cross-section decreasing further away from a lengthwise direction.

In addition, in the drawing, to stably support the contact pressure springs 130, the first protrusion 121 and the second protrusion 122, and the first fitting protrusion 143 and the second fitting protrusion 144 are illustrated as having a shape protruding from surfaces, but are not limited thereto.

The first protrusion 121 and the second protrusion 122, and the first fitting protrusion 143 and the second fitting protrusion 144 may be also configured in a shape of a hole or a groove to stably support the contact pressure springs 130.

Referring back to FIG. 4, as described above, the relay 1 having the arc induction shield structure according to an embodiment of the present disclosure includes the arc induction pin 160 arranged on one side of the chamber space 102a to induce a direction of the generated arc A and cause the arc A to extend, and the arc guard portion G having a form surrounding the housing 140 to block the generated arc A from moving in a direction toward the contact pressure springs 130.

The arc induction pin 160 induces the generated arc A to extend to a length sufficient for arc extinguishing.

As one embodiment for implementing this, the arc induction pin 160 is made of a magnetic material having a column shape with a preset length and diameter.

The arc induction pin 160 may desirably have a length a (in FIG. 6) greater than a length of the movable contact 120 in a width (front-and-back) direction, and is arranged to have a length in the front-and-back direction within the chamber space 102a.

In detail, the arc induction pin 160 may have a shape including a column portion 161 having a set length and diameter and head portions 162 protruding to define stopping parts 163 at both end portions of the column portion 161.

In the drawing, the arc induction pin 160 is illustrated as having a cylindrical shape, but is not limited thereto. When capable of inducing the arc A, the arc induction pin 160 may have a cross-section with various column shapes such as a circle, an ellipse, and a polygon.

However, the arc induction pin 160 may be desirably arranged in a lower portion of the chamber space 102a to have a length in a front-and-back direction to thereby induce the generated arc A to extend to a sufficient length.

Meanwhile, the arc induction pin 160 is supported by a guard wall portion 150 placed on an insulating plate 103 arranged on the support plate 26.

The insulating plate 103 physically and electrically separates the chamber space 102a from the driving module 20 arranged therebelow.

Components accommodated in the chamber space 102a and components accommodated on a side of the driving module 20 are electrically separated by the insulating plate 103 not to electrically influence each other.

The insulating plate 103 has a form stacked on the support plate 26 and may have a through hole arranged therein to allow the shaft 21 to move in an up-and-down direction.

In one embodiment, the insulating plate 103 is made of an insulating material which may include a rubber or ceramic material.

Meanwhile, the guard wall portion 150 placed on an upper surface of the insulating plate 103 may function to block the arc A from being directed toward the contact pressure springs 130 or the shaft 21.

Thus, the guard wall portion 150 has a guard wall 151 arranged vertically and having a set height and width on an upper surface of the insulating plate 103.

In addition, the guard wall portion 150 has a structure including a rib 152 extending from one surface of the guard wall 151 to be inclined in a direction away from the movable contact 120.

At this time, the rib 152 may be arranged as a single piece or in a plurality of pieces spaced apart from each other as needed.

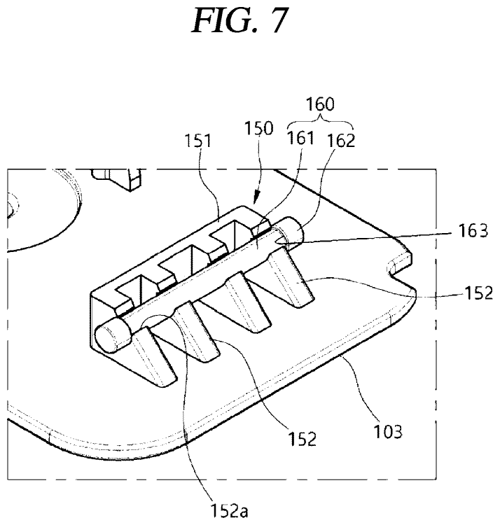

Meanwhile, the rib 152 has a seating groove 152a defined on one side to allow the arc induction pin 160 to be seated and supported (see FIG. 7).

As such, as the arc induction pin 160 is supported by being seated in the seating groove 152a of the guard wall portion 150, the arc induction pin 160 may be positioned in a space on one side in the chamber space 102a.

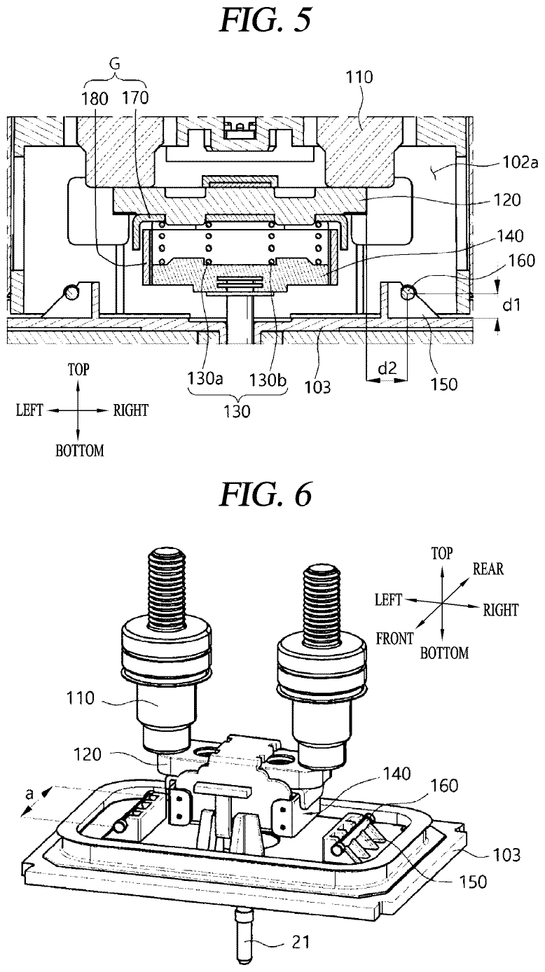

In other words, the arc induction pin 160 may be arranged to have a spacing d1 defined by the guard wall portion 150 in a direction away from an upper surface of the insulating plate 103, and a spacing d2 in a longitudinal direction with respect to a longitudinal end of the movable contact 120 (see FIG. 5).

The spacings d1 and d2 of the arc induction pin 160 may be set according to a size of the arc chamber 102.

According to the arrangement of the arc induction pin 160 as described above, the arc A generated within the chamber space 102a may be induced toward the arc induction pin 160 to extend to a length sufficient for arc extinguishing.

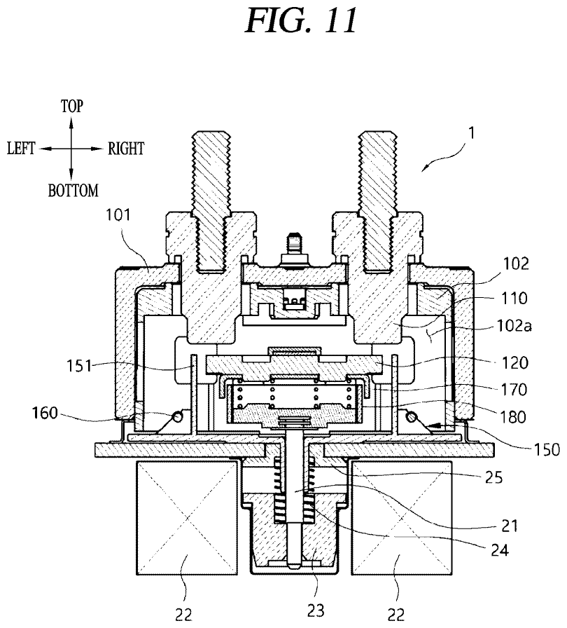

Meanwhile, referring to FIG. 11, the guard wall 151 of the guard wall portion 150 may be arranged to have a height extending from an upper surface of the insulating plate 103 to a position corresponding to an upper side of the movable contact 120.

As one example, the guard wall 151 may be arranged to extend to a height of an upper end of the movable contact 120.

Accordingly, the generated arc A is blocked by the guard wall 151, and thus, an impact on the contact pressure springs 130 or the shaft 21 is also suppressed.

Desirably, the guard wall 151 has a width (length) greater than a length of the movable contact 120 in a width (front-and-back) direction.

As described above, the relay 1 having the arc induction shield structure according to an embodiment of the present disclosure has the arc guard portion G having a form surrounding the housing 140 to block the generated arc A from moving in a direction toward the contact pressure springs 130.

The arc guard portion G may be broadly divided into a first guard 170 and a second guard 180.

First, the first guard 170 is made of a magnetic material.

The first guard 170 is arranged on a lower surface of the movable contact 120 and guides a direction of the arc A extending through the arc induction pin 160 toward the first guard 170.

The first guard 170 may block the generated arc A from moving toward the contact pressure springs 130.

As one embodiment, the first guard 170 has a size and a shape each identical to those of the lower surface of the movable contact 120.

In addition, the first guard 170 is arranged to be in contact with the lower surface of the movable contact 120.

Meanwhile, the first guard 170 may be in a form of a first plate 171 having a plate shape arranged to be in contact with the lower surface of the movable contact 120.

In addition, the first guard 170 may be in a form further including second plates 172 extending downward from both longitudinal (left-and-right) end portions of the first plate 171 (see FIG. 9).

The second plates 172 may each have a size and a shape such that openings in both side portions defined by the body 141 of the housing 140 may be completely covered, or may have a size and a shape such that the openings may be partially covered as needed.

Meanwhile, in the relay 1 having the arc induction shield structure according to an embodiment of the present disclosure, the arc guard portion G may be a second guard 180 that covers each of both open side portions in the body 141 of the housing 140.

At this time, the second guard 180 may be configured as a same insulator as that of the insulating plate 103.

The second guard 180 covers the both side portions of the body 141 to block the generated arc A from moving toward the contact pressure springs 130.

In one embodiment, referring to FIGS. 8 and 9, the second guard 180 has a structure including a first plate 181 having a size and a shape such that the both open side portions in the body 141 may be covered, and second plates 182 extending from both side portions of the first plate 181 in a direction toward the mounting space 146.

At this time, the body 141 may have protrusions 147 arranged on both side surfaces at an outer end portion, and the second plates 182 may each have protrusion grooves 182a corresponding to the protrusions 147.

As the protrusions 147 and the protrusion grooves 182a are coupled to each other, the second guard 180 may be detachably coupled to the housing 140.

Shapes and locations of the protrusions 147 and the protrusion grooves 182a are not limited thereto, and may be interchangeably configured.

In addition, when the second guard 180 has a structure of being detachably coupled to the housing 140, a rail (not shown) may be arranged on an outer surface of the body 141 and the second guard 180 may be slidably coupled along the rail.

Meanwhile, the first guard 170 and the second guard 180 constituting the arc guard portion G have been described as separate components above. However, the first guard 170 and the second guard 180 may be included together.

The arc guard portion G including both the first guard 170 and the second guard 180 together may completely block the generated arc A from moving toward the contact pressure springs 130.

As described above, the relay 1 including the arc induction shield structure according to an embodiment of the present disclosure has the arc induction pin 160 in the chamber space 102a and induces the generated arc A to the arc induction pin 160 to thereby extend the generated arc A to a length sufficient for arc extinguishing, Thus, the arc A may be effectively extinguished.

In addition, as the generated arc A is induced to the arc induction pin 160 and extended, the arc A may be prevented from coming into contact with components such as the shaft 21 or the contact pressure springs 130.

In addition, the arc guard portion G, which surrounds the housing 140 having the contact pressure springs 130 arranged in the mounting space 146, blocks any potential arc A from coming into contact with components such as the shaft 21 or the contact pressure springs 130. Thus, a mechanical lifespan and electrical reliability of a product may be improved.

In addition, as the generated arc A is induced to the arc induction pin 160, the arc A does not remain at a minimum distance between the fixed contacts 110 and the movable contact 120. Thus, fusion between the fixed contacts 110 and the movable contact 120 and damage to the product may be prevented.

Although embodiments of the present disclosure have been described, the aspects of the present disclosure described as above is not limited by the embodiments described herein. It should be apparent to those skilled in the art that various additions, changes, deletions, and modifications of components which are not exemplified herein but are still within the spirit and scope of the present disclosure may be made.

1. A relay having an arc induction shield structure, the relay comprising:
a fixed contact electrically connected to an external power source or load;
a movable contact brought into contact with or separated from the fixed contact;
a contact pressure spring configured to support a lower portion of the movable contact to apply elastic force; and
an arc induction pin configured to induce a direction of an arc, which has been generated, such that the arc extends.

2. The relay of claim 1, wherein the arc induction pin is made of a magnetic material having a column shape with a preset length and diameter,
has a length greater than a length of the movable contact in a widthwise direction of the moveable contact, and
is arranged to have a length in a front-and-back direction.

3. The relay of claim 2, wherein the arc induction pin comprises
a column portion having a set length and diameter, and
head portions protruding to define stopping parts at both end portions of the column portion.

4. The relay of claim 1, further comprising:
a housing configured to accommodate the contact pressure spring in a mounting space, and be lifted or lowered by a shaft coupled to a lower portion of the housing; and
an arc chamber configured to accommodate the fixed contact, the movable contact, and the housing in a chamber space.

5. The relay of claim 4, wherein the housing comprises:
a body having a shape of an enclosure with open upper and both side portions, defining the mounting space therein, and having a lower portion coupled to the shaft; and
a holder plate configured to partially block the open upper portion of the body and support an upper surface of the movable contact by being in contact with the upper surface of the movable contact.

6. The relay of claim 4, wherein the arc induction pin is arranged
to have a spacing in a direction away from an upper surface of an insulating plate, which blocks a lower portion of the chamber space and has the shaft inserted therethrough, and
to have a spacing in a longitudinal direction from a longitudinal end portion of the movable contact.

7. The relay of claim 6, wherein the insulating plate further comprises a guard wall portion arranged thereon, the guard wall portion being configured to support the arc induction pin.

8. The relay of claim 7, wherein the guard wall portion comprises
a guard wall having a set height and width on the upper surface of the insulating plate and arranged vertically, and
a rib extending from one surface of the guard wall to be inclined in a direction away from the movable contact.

9. The relay of claim 8, wherein the guard wall extends to a height of an upper end portion of the movable contact.

10. The relay of claim 8, wherein the rib has a seating groove formed on one side thereof, and
the arc induction pin is seated in the seating groove.
